(19) United States
(12) Patent Application Publication
(10) Pub. No.: US 2007/0267067 A1
(43) Pub. Date: Nov. 22, 2007

(54) VALVE FOR A SNORKEL

(75) Inventor: Chen-Lieh Pan, Yilan Hsien (TW)

Correspondence Address: PAI PATENT & TRADEMARK LAW FIRM, 1001 FOURTH AVENUE, SUITE 3200, SEATTLE, WA, 98154, US

(73) Assignee: WATER SQUARE SPORTS CO., LTD., Sanchong City (TW)

(21) Appl. No.: 11/383,621

(22) Filed: May 16, 2006

(51) Int. Cl. F16K 31/18

(52) U.S. Cl. 137/433

(57) ABSTRACT

A valve for a snorkel has a body, a floating cylinder and a seat. The body has a floating cylinder chamber. The floating cylinder chamber is formed inside the body and has a top opening, a bottom and a tracking extension. The tracking extension is formed at the bottom of the floating chamber. The floating cylinder is slidably mounted inside the floating cylinder chamber and has a bottom and a channel. The channel is formed at bottom of the floating cylinder and receives the tracking extension of the floating cylinder chamber to guide the floating cylinder toward to certain direction. The seat is mounted at the top opening of the floating cylinder chamber and has a cushion. The cushion is bellows-shaped and is mounted on the seat. When the cushion abuts against the floating cylinder, the cushion is adjustable at angle to seal tightly the floating cylinder chamber.

### BACKGROUND OF THE INVENTION

1. Field of the Invention

The present invention relates to a valve, and more particularly to a valve for a snorkel and that is able to prevent a user to inhale water when the user is using the snorkel during water sport.

2. Description of Related Art

A conventional snorkel in accordance with the present invention has a pipe, a mouthpiece and a valve. The pipe is hollow and has a top opening and a bottom opening. The top opening and the bottom opening are formed on the pipe and communicate with each other. The mouthpiece is mounted at bottom end of the pipe and allows a user to hold in the mouth and breath through the pipe. With reference to FIGS. 4 and 5, the valve is mounted at top end of the pipe and has a body (50), a floating cylinder (60), a seat (70) and a top cover (80).

The body (50) has a top, a floating cylinder chamber (51) and an air chamber (52). The floating cylinder chamber (51) is hollow, formed inside the body (50) and has a top opening, an inner wall and water-discharging holes (53). The top opening is formed on the floating chamber (51). The water-discharging holes (53) are separately formed through the inner wall of the floating chamber (51) of the body (51).

The air chamber (52) is hollow, formed inside the body (50) and adjacent to the floating cylinder chamber (51) and has a top opening, a bottom and an air passage (54). The top opening is formed on the air chamber (52). The air passage (54) is formed through the bottom of the air chamber (52), communicates with the top opening of the air chamber (52) and allows the top opening of the pipe to mount into.

The floating cylinder (60) is slidably mounted inside the floating cylinder chamber (51) of the body (50) and has a top. A gap is defined between the floating cylinder (60) and the inner wall of the floating cylinder chamber (51) and allow the floating cylinder (60) to move when a force acts onto the body (50) or a foreign matter, such as a seaweed or sands, accidentally get into the floating cylinder chamber (51).

The seat (70) is annular, is mounted at the top opening of the floating cylinder chamber (51) and has a bottom and a cushion (71). With further reference to FIG. 6, the cushion (71) is annular, is mounted on the bottom of the seat (70) and selectively abuts against the top of the floating cylinder (60) to seal the top opening of the floating cylinder chamber (51) when the floating cylinder (60) is floating toward the top opening of the floating cylinder chamber (51).

The top cover (80) is mounted on the top of the body (50).

A user breathes through the snorkel when the user is taking a water sport. When the user dives to a certain depth, the water can flow into the floating cylinder chamber (51) through the water-discharging holes (53) so that the floating cylinder (60) floats toward to top opening of the floating cylinder chamber (51). With further reference to FIG. 6, the top of the floating cylinder (60) abuts against to the cushion (71) of the seat (70) to seal the top opening of the floating cylinder chamber (51). Consequently, the water cannot go through the top opening of the floating cylinder chamber (51) and get into the air chamber (52) of the body (50) so that the user will not inhale the water through the snorkel to prevent the user get chock from the water in the snorkel.

The snorkel requires to be perpendicular to the water surface when the user dives into the water so that the floating cylinder (60) is able to float vertically to seal tightly the top opening of the floating cylinder chamber (51). However, the user is not able to keep certain position or depth when the user dives into the water. The snorkel may not be perpendicular to the water surface so that the floating cylinder (60) floats with an angle to the floating cylinder chamber (51). The floating cylinder (60) is unable to seal the top opening of the floating cylinder chamber (51). The water may go through the top opening of the floating cylinder chamber (51) and get into the air chamber (52) so that the user inhales the water from the air chamber (52) and then get chuck. The conventional snorkel can not prevent the user from getting chuck.

To overcome the shortcomings, the present invention provides a valve for a snorkel to obviate or mitigate the aforementioned problems.

### SUMMARY OF THE INVENTION

The primary objective of the present invention is to provide a valve for a snorkel that is able to seal tightly the snorkel to prevent a user from getting chock when the user is diving.

The valve for a snorkel has a body, a floating cylinder and a seat. The body has a floating cylinder chamber. The floating cylinder chamber is formed inside the body and has a top opening, a bottom and a tracking extension. The tracking extension is formed at the bottom of the floating chamber. The floating cylinder is slidely mounted inside the floating cylinder chamber and has a bottom and a channel. The channel is formed at bottom of the floating cylinder and receives the tracking extension of the floating cylinder chamber to guide the floating cylinder toward to certain direction. The seat is mounted at the top opening of the floating cylinder chamber and has a cushion. The cushion is bellows shape, mounted on the seat. When the cushion abuts against to the floating cylinder, the cushion can adjust angle to the floating cylinder to seal tightly the floating cylinder chamber.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a valve for a snorkel in accordance with the present invention;

FIG. 2 is a cross sectional side view of the valve for a snorkel in FIG. 1;

FIG. 3 is an operational cross sectional side view of the valve for a snorkel in FIG. 1 when a floating cylinder abuts against to a cushion of a seat;

FIG. 4 is an exploded perspective view of a conventional valve for a snorkel in accordance with the prior art;

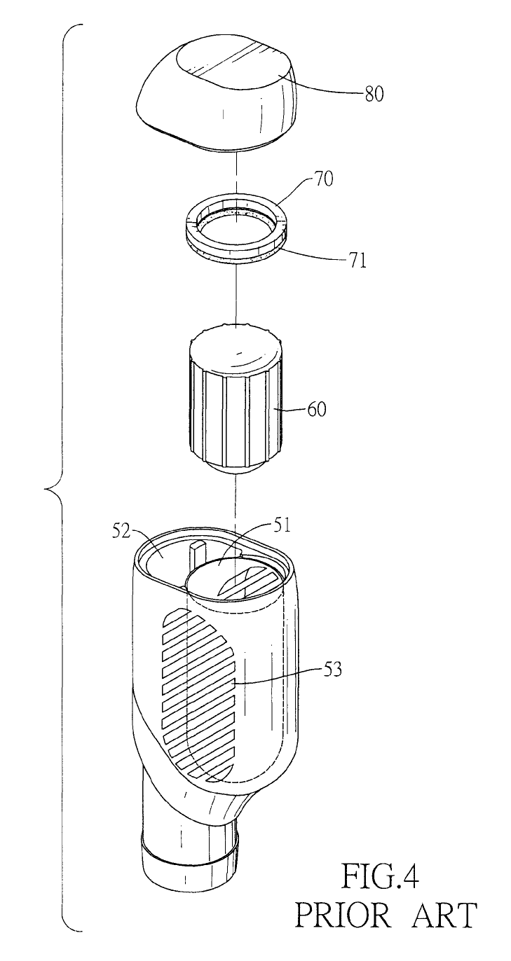

FIG. 5 is a side view in partial section of the conventional valve for a snorkel in FIG. 4; and

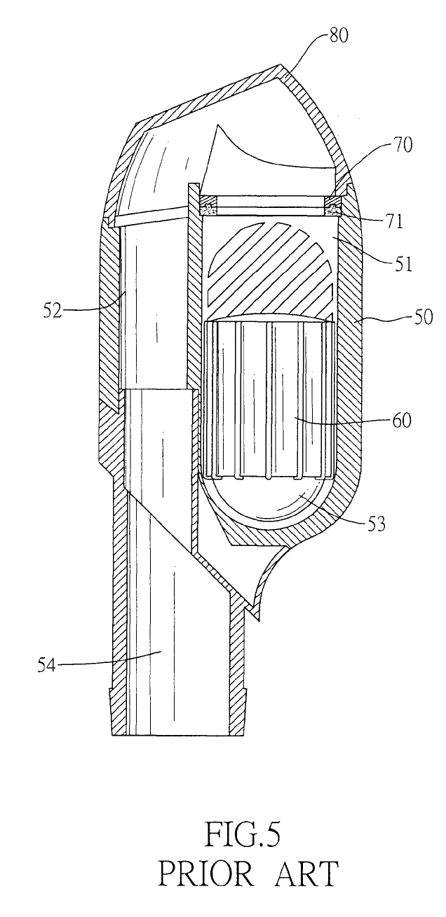

FIG. 6 is a side view in partial section of the conventional valve for a snorkel in FIG. 4 when a floating cylinder abuts against to a cushion of a seat.

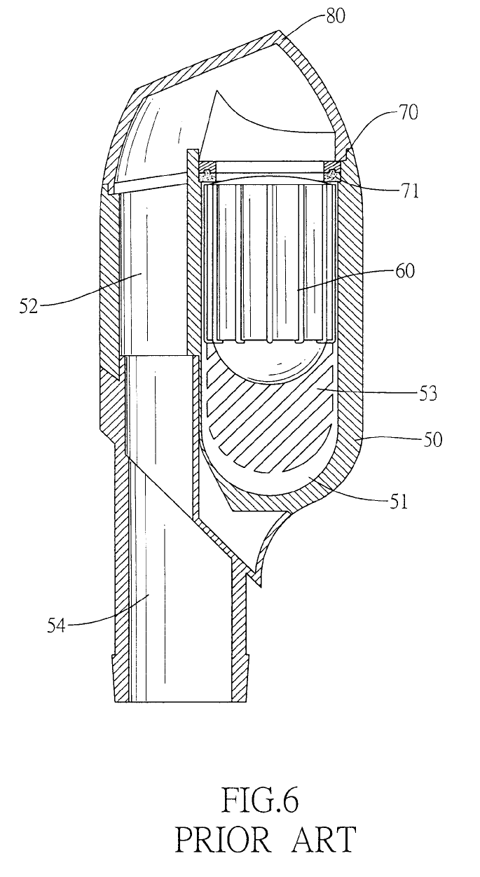

### DETAILED DESCRIPTION OF THE PREFERRED EMBODIMENT

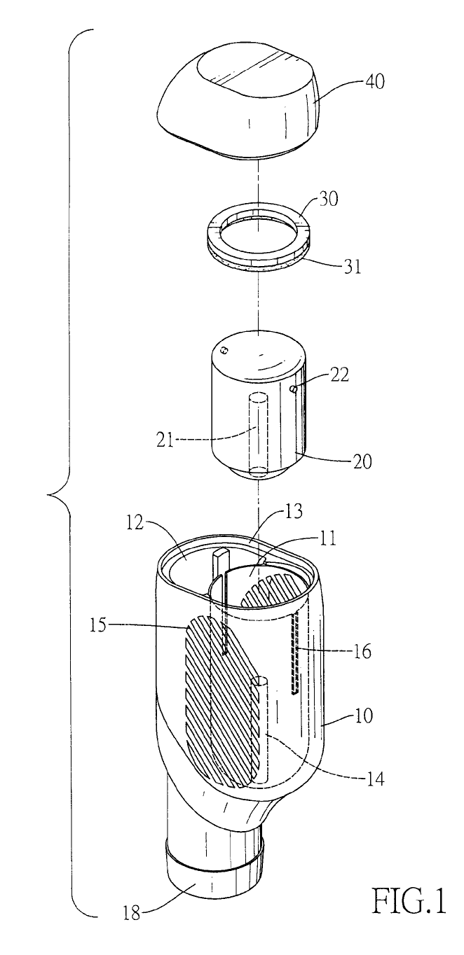

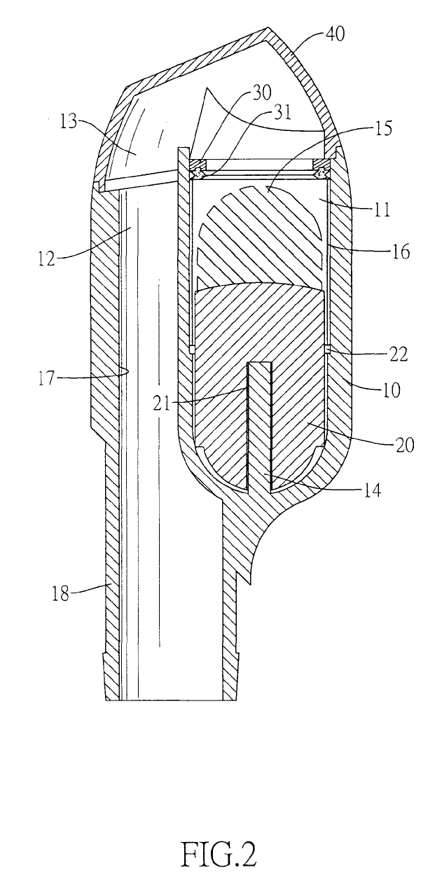

With reference to FIGS. 1 and 2, a valve in accordance with the present invention for a snorkel having a pipe and a mouthpiece has a body (10), a floating cylinder (20), a seat (30) and a top cover (40).

The pipe is hollow and has a top opening and a bottom opening. The top opening and the bottom opening are formed on the pipe and communicate with each other. The mouthpiece is mounted at bottom opening of the pipe and allows a user to hold in the mouth and breath through the pipe.

The body (10) has a top, a floating cylinder chamber (11) and an air chamber (12). The floating cylinder chamber (11) is hollow, formed inside the body (10) and has a top opening, a bottom, an inner wall, a tracking extension (14), two optional tracking slots (16) and water-discharging holes (15). The top opening is formed on the floating chamber (11). The tracking extension (14) is formed at the bottom of the floating chamber (11) and extends upward. The two tracking slots (16) are formed at the inner wall of the floating chamber (11) and correspond to each other. The water-discharging holes (15) are separately formed through the inner wall of the floating chamber (11) and correspond to each other to allow water quickly to be discharged from the floating chamber (11).

The air chamber (12) is hollow, is formed inside the body (10) adjacent to the floating cylinder chamber (11) and has a top opening, a bottom, an air passage (17) and an optional tube (18). The top opening is formed on the air chamber (12). The air passage (17) is formed through the bottom of the air chamber (12) and communicates with the top opening of the air chamber (12). The tube (18) is mounted is mounted at the air passage (17) and has a through hole. The though hole is formed through the tube (18) and communicates with the air chamber (12). The tube (18) may be formed together with the air chamber (12) of the body (10) or separated from the air chamber (12) of the body (10). The tube (18) is mounted to the top opening of pipe of the snorkel so that the body (10) is able to combine to valve with the pipe of the snorkel together.

The floating cylinder (20) is slidely mounted inside the floating cylinder chamber (11) of the body (10) and has a top, a bottom, a sidewall, a channel (21) and two optional protrusions (22). The channel (21) is formed at bottom of the floating cylinder (20) and receives the tracking extension (14) of the floating cylinder chamber (11) to guide the floating cylinder (20) only moving along a certain direction when the floating cylinder (20) floating. The two protrusions (22) are formed on the sidewall of the floating cylinder (20), correspond to each other and slidably engage respectively with the two tracking slots (16) of the floating chamber (11).

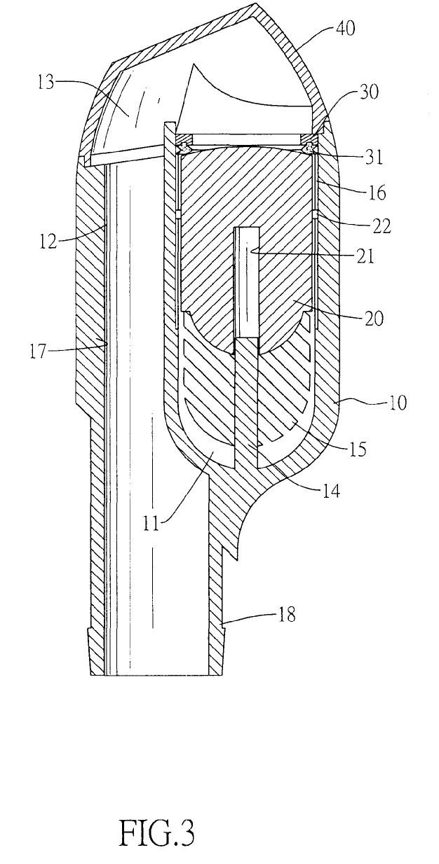

The seat (30) is annular, is mounted at the top opening of the floating cylinder chamber (11) and has a bottom and a cushion (31). With further reference to FIGS. 2 and 3, the cushion (31) is annular, is bellows-shaped, is mounted on the bottom of the seat (30) and selectively abuts against the top of the floating cylinder (20) to seal the top opening of the floating cylinder chamber (11) when the floating cylinder (30) is floating toward the top opening of the floating cylinder chamber (11). Furthermore, the cushion (31) has a bellows shape so that the cushion (31) is adjustable at angle when the top of the floating cylinder (20) abuts against the cushion (31) to seal tightly the top opening of the floating cylinder chamber (11).

The top cover (40) is mounted on the top of the body (10).

Accordingly, a guiding effect is provided to the floating cylinder (20) by the racking extension (14), the tracking slots (16), the and channel (21) and two protrusions (22), so that the floating cylinder (20) can move along a certain direction even when the snorkel is not perpendicular to the water surface. Furthermore, the cushion (31) has a bellows shape so that the cushion (31) can tightly abut against the cushion (31) to completely seal the top opening of the floating cylinder chamber (11) and to prevent a user from getting chock.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A valve for a snorkel comprising
a body having
a top;
a floating cylinder chamber being hollow, formed inside the body and having
a top opening formed in the floating chamber;
a bottom;
an inner wall;
a tracking extension formed at the bottom of the floating chamber and extending upward; and
multiple water-discharging holes separately formed through the inner wall of the floating chamber and corresponding to each other; and
an air chamber being hollow, formed inside the body adjacent to the floating cylinder chamber and having
a top opening formed in the air chamber;
a bottom; and
an air passage formed through the bottom of the air chamber and communicating with the top opening of the air chamber;
a floating cylinder slidably mounted inside the floating cylinder chamber of the body and having
a top;
a bottom;
a sidewall; and
a channel formed at bottom of the floating cylinder and receiving the tracking extension of the floating cylinder chamber;
a seat being annular, mounted at the top opening of the floating cylinder chamber and having
a bottom; and
a cushion being annular, being bellows-shaped, mounted on the bottom of the seat and selectively abutting against to the top of the floating cylinder; and
a top cover mounted on the top of the body.

2. The valve for a snorkel as claimed in claim 1, wherein the floating cylinder chamber of the body further has two tracking slots formed at inner wall of the floating chamber and corresponding to each other;
the floating cylinder further has two protrusions formed on the sidewall of the floating cylinder, corresponding to each other and slidely engaging respectively with the two tracking slots of the floating chamber.

3. The valve for a snorkel as claimed in claim 2, wherein the body further has a tube with a through hole mounted at the air passage of the air chamber of the body.
